(19) United States
(12) Patent Application Publication
(10) Pub. No.: US 2024/0414562 A1
(43) Pub. Date: Dec. 12, 2024

(54) LEARNING-BASED ADAPTIVE TUNING OF 5G CONTROL PARAMETERS

(71) Applicant: Microsoft Technology Licensing, LLC, Redmond, WA (US)

(72) Inventor: Manikanta KOTARU, Kenmore, WA (US)

(73) Assignee: Microsoft Technology Licensing, LLC, Redmond, WA (US)

(21) Appl. No.: 18/208,718

(22) Filed: Jun. 12, 2023

(51) Int. Cl. H04W 24/02

(52) U.S. Cl. CPC H04W 24/02

(57) ABSTRACT

Systems and methods are provided for determining a set of control parameter data associated with a base station of a 5G multi-access edge computing and core network. In particular, the disclosed technology is directed to use a deep reinforcement-based learning (DRL) model to iteratively reinforce and improve the set of control parameter data at the base station. The DRL model determines the set of control parameter data as action based on a current set of network state data as state, according a set of target conditions used as rewards. A DRL server periodically receives network state data from the base station through a radio access network intelligent controller (RIC). Given the network state data, the DRL model determines control parameter data as output. The DRL server transmits the control parameter data to the base station via RIC. The periodic reinforcement-based learning dynamically improves a network performance of the base station.

### BACKGROUND

With the advent of 5G, tuning of control parameters associated with various parts of the 5G system has become important. For instance, base stations include a variety of control parameters that need to be updated to accommodate connections with various types of communication devices over the cellular wireless radio communications. The base stations connect with switches and servers associated with multi-access Edge Computing (MEC) and the cloud to form data analytics pipelines. MEC aims to support a variety of broadband service applications by using a hierarchy of devices and servers. Examples of the communication devices include Internet-of-Things (IoT) devices, e.g., cameras of personal or commercial security systems, municipal traffic cameras, and the like. The IoT devices capture and transmit stream data (e.g., video data) to cell towers and the base stations associated with the cell towers. The base stations relay the stream data to edge servers in on-premises (i.e., “on-prem”) edges as uplink data traffic. The on-premises edge servers transmit the uplink data traffic to network servers at network edges of a cloud infrastructure, and the network servers further transmit the uplink data traffic to cloud servers for processing.

Achieving optimal performance under a variety of use case scenarios associated with the base station has become complex because of a vast number of control parameters that need to be updated in the base stations. The base station connects with a cell tower and on-premises edges to process data traffic in a radio communication layer, a physical layer, and a link layer. The customizing of the control parameters includes setting a variety of control policies that affect how data traffic flows from the IoT devices to the on-premises edge through the base stations. The sheer number of control parameters makes manual tuning very difficult. In particular, manually updating control parameters to operate geographically distributed base stations with cell towers (e.g., gNB) is insufficient to optimize or otherwise improve data flows according to service applications.

Accordingly, there arises a tension between accommodating a variety of types of IoT devices and service applications with distinct characteristics of data flows in the system and increasing complexity of maintaining control parameter values at the base stations. There has been a need to efficiently update, in near real-time and non-real-time, control parameters at the base stations and at the respective levels of the hierarchy in MEC and other parts of the 5G, 6G, and other telecommunications networks. It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Aspects of the present disclosure relate to determining values of control parameters based on the current network state data associated with operating a base station and dynamically updating the control parameter data with the determined values at the base station. In particular, the disclosed technology uses a deep reinforcement-based machine learning model to determine the set of control parameter data based on the current network state data. The determined control parameter data improves a performance of the base station and thus improves operation of the data analytics pipeline in multi-access edge computing (MEC) system in the 5G, 6G, and other telecommunication networks. The deep reinforcement-based machine learning framework determines the control parameter data that optimizes or otherwise improves spectral efficiency and/or other aspects of performance at the base station.

As noted above, the MEC involves a hierarchy of data centers and servers with a variety of services that are installed for execution. The MEC includes one or more edge servers in an on-premises edge datacenter of a private cloud network that may interface with a radio access network (RAN). In aspects, the term “on-premises edge” may refer to a datacenter at a remote location (e.g., at the far-edge of a private cloud), which is in proximity to one or more cell towers and base stations. The RAN, in combination with a core network of a cloud service provider, represents a backbone network for mobile wireless telecommunications. For example, cell towers at base stations may receive and transmit radio signals to communicate with IoT devices (e.g., video cameras) over a RAN (e.g., 5G). Various service applications may perform different functions, such as network monitoring or video streaming, and may be responsible for evaluating data associated with the data traffic. For instance, a service application may perform data analytics, such as object recognition (e.g., object counting, facial recognition, human recognition) on a video stream. In aspects, the term “5G/6G MEC and core network system” includes the MEC and the core network system in the 5G or 6G telecommunication networks. In aspects, a program instruction includes one or more codes that expresses and executes as functions.

In aspects, the term “gNB” refers to a node (e.g., gNodeB) that provides connectivity between user equipment (e.g., a user equipment (UE), an IoT device, a wireless device, a smartphone, and the like) and a data packet core (e.g., MEC and core network system). Examples of a gNB includes a base station associated with a cell tower in a cellular telecommunication network.

In aspects, the term “O-RAN” refers to Open Radio Access Network technical standards. In particular, the O-RAN standard includes “E2” interface, which defines data communication protocols between Radio Access Network (RAN) intelligent controller (RIC) and RAN control unit (CU) and distributed unit (DU) that may include a base station (e.g., gNB). The “E2” interface may include “E2 Control” interface, which defines a control procedure initiated by RIC. “E2 Monitor” interface defines a procedure initiated by the base station to transmit network state data to RIC.

In aspects, the term “reinforcement-based learning” refers to a machine learning approach where an agent learns to make decisions by interacting with the environment and receiving a reward or a punishment as a result. The agent's goal is to maximize the cumulative reward over time. Deep reinforcement-based learning (DRL) is an extension of reinforcement-based learning by integrating the reinforcement-based learning with deep learning by using deep neural networks. A deep reinforcement-based machine learning model includes the agent's policy and value function to determine actions based on a state and rewards.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTIONS OF THE DRAWINGS

Non-limiting and non-exhaustive examples are described with reference to the following figures.

FIG. 1 illustrates an overview of an example system for monitoring states and dynamically updating control parameters associated with a base station using deep reinforcement-based learning in accordance with aspects of the present disclosure.

FIG. 2A illustrates an example system for monitoring states and dynamically updating control parameters associated with a base station using deep reinforcement-based learning in accordance with aspects of the present disclosure.

FIG. 2B illustrates an example system for monitoring states and dynamically updating control parameters associated with a base station using deep reinforcement-based learning in accordance with aspects of the present disclosure.

FIG. 3A illustrates an example of network state data in accordance with aspects of the present disclosure.

FIG. 3B illustrates an example of reward data in accordance with aspects of the present disclosure.

FIG. 3C illustrates an example of control parameters in accordance with aspects of the present disclosure.

FIG. 4A illustrates an example of a method for monitoring states and dynamically updating control parameters associated with a base station using deep reinforcement-based learning in accordance with aspects of the present disclosure.

FIG. 4B illustrates an example of a method for determining control parameter data using a deep reinforcement-based learning model in accordance with aspects of the present disclosure.

FIG. 5 illustrates an example of a method for training a deep reinforcement-based learning model in accordance with aspects of the present disclosure.

FIG. 6 is a block diagram illustrating example physical components of a computing device with which aspects of the disclosure may be practiced.

FIG. 7 is a simplified block diagram of a computing device with which aspects of the present disclosure may be practiced.

### DETAILED DESCRIPTION

Various aspects of the disclosure are described more fully below with reference to the accompanying drawings, which from a part hereof, and which show specific example aspects. However, different aspects of the disclosure may be implemented in many different ways and should not be construed as limited to the aspects set forth herein; rather, these aspects are provided so that this disclosure will be thorough and complete and will fully convey the scope of the aspects to those skilled in the art. Practicing aspects may be as methods, systems, or devices. Accordingly, aspects may take the form of a hardware implementation, an entirely software implementation or an implementation combining software and hardware aspects. The following detailed description is, therefore, not to be taken in a limiting sense.

Operating base stations with cell towers as distributed data processing in a 5G/6G MEC and core network system has increased its complexity. IoT devices may transmit and receive data from a base station (e.g., a gNB) and connect via cloud services to a public network (e.g., the Internet) and/or a private network. The cloud service provider may implement a vast array of virtual servers and other computing resources to dynamically scale computing capacity as needed based on the volume of data traffic. To enable real-time processing of data traffic, an on-premises edge server may be relatively close (e.g., a few kilometers) to the base stations with cell towers.

Updating control parameter data for operating base stations involves the daunting task of determining a large number of control parameter data based on the current network state. In examples, the updating may occur on multiple occasions, for example since desirable values of the control parameters to improve performance of the base stations change over time as the network state changes over time. Manually adjusting the control parameters associated with base stations is insufficient to optimizes or otherwise improves operations of data flows from the IoT devices through the base stations to the MEC and core network. Furthermore, updating the control parameter data from remote locations is needed because the base stations are geographically distributed across regions.

A variety of types of control parameters makes optimizing the control parameter values complex. Examples of types of control parameters include, but are not limited to: parameters associated with MAC scheduling algorithm for prioritized data processing, numerology that includes subcarrier spacing and a symbol duration for radio channels for over-the-air communications, cyclic prefix length (e.g., a length of the guard interval for preventing inter-symbol interference between radio channels), reference signal density, signal transmit power, mobility management (MM) parameters, and the like. Some of the control parameters may have near real-time needs for updating control parameter data.

In aspects, the present disclosure uses deep reinforcement-based learning to dynamically determine, and update control parameter data based on the current network state. A deep reinforcement-based learning server (“a DRL Server”) connects to a real-time RAN intelligent controller (“RIC RT”) and/or a non-real-time RAN intelligent controller (“non-RT RIC). The DRL server requests for and receives network state data from a base station through the RIC RT and/or the non-RT RIC. The DRL server includes a deep reinforcement-based learning model (“a DRL model”). The DRL model determines control parameter values based on the received network state data. The RIC RT and/or the Non-RT RIC instructs the base station to update control parameter values as determined by the DRL server. Systems according to the disclosed technology iteratively executes receiving the network state data, determining a new set of control parameter data using a DRL model, and updating a base station according to the new set of control parameter data. Use of the DRL model enables dynamically generating a set of complex control parameter data and iteratively improving a performance of the base station according to the reinforcement-based learning.

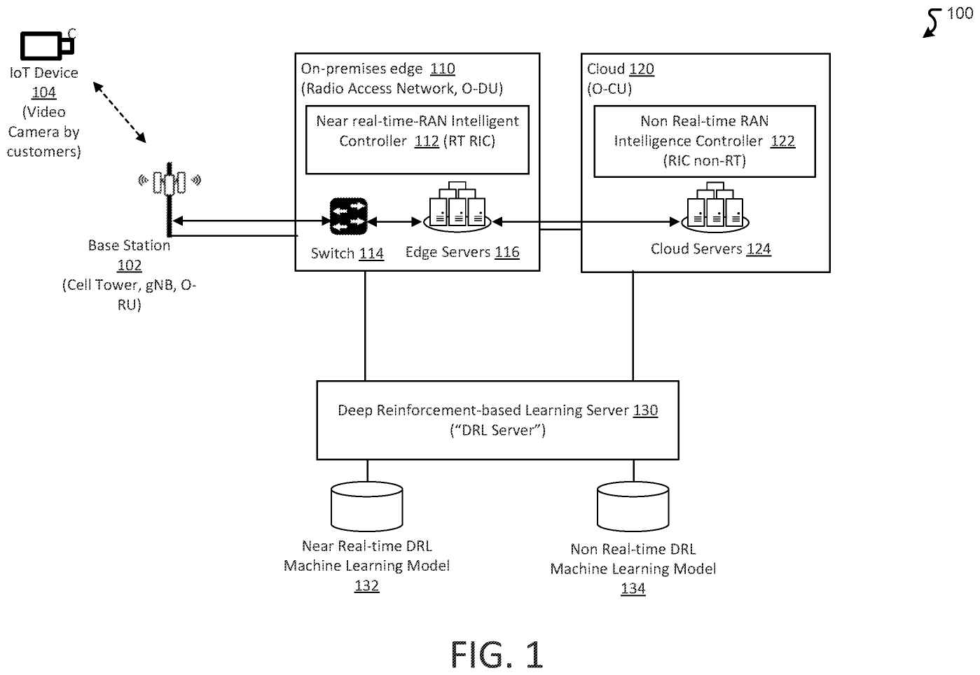

FIG. 1 illustrates an overview of an example system for monitoring states and dynamically updating control parameters associated with a base station using a deep reinforcement-based learning in accordance with aspects of the present disclosure. An example system 100 includes a base station 102 (e.g., a cell tower, gNB, Open RAN Radio Unit (O-RU) according to O-RAN, and the like), an IoT device 104 (e.g., a user equipment (UE), a video camera for surveillance, a sensor, a smartphone, and the like), On-premises edge 110, cloud 120, and deep reinforcement-based learning server 130 (DRL server). Base station 102 with a cell tower transmits and receives wireless communications with the IoT device (e.g., video cameras, health monitors, watches, appliances, etc.) over a cellular wireless network. A video camera represents an example of the IoT device 104, which is communicating with at least the base station 102 in the field. In aspects, the IoT device 104 is capable of capturing video images and transmitting the captured video images over a cellular wireless network (e.g., the 5G/6G cellular network) to the base station 102. For example, at least the IoT device 104 as the video camera may capture scenes for purposes of video surveillance, such as traffic surveillance or security surveillance. It will be appreciated that IoT device 104 may be any of a variety of other devices, that alternatively, or additionally, generate a variety of other types of data.

In aspects, the base station 102 operates based on a set of control parameters. As discussed in details below, the control parameters may include, but are not limited to, media access control (MAC) scheduling algorithms, numerology, cyclic prefix length, reference signal density, signal transmit power, mobility management (MM) parameters, and the like. For example, a MAC scheduling algorithm determines a priority level for scheduling data transmission associated with the IoT device 104 connected to the base station 102. The numerology refers to subcarrier spacing of signal frequency bands and a symbol duration for radio channels for over-the-air (OTA) wireless communications.

The example system 100 further includes an on-premises edge 110 (e.g., including switches, edge servers), and a cloud 120 (e.g., including cloud servers responsible for providing cloud services). In aspects the cloud 120 includes core network servers. In aspects, the example system 100 includes a cloud RAN infrastructure for a mobile wireless telecommunication network.

As illustrated, the on-premises edge 110 is a datacenter that is part of a cloud RAN. The on-premises edge 110 includes switch 114 and edge servers 116. The edge servers 116 may execute near real-time RAN intelligent controller 112 (RT RIC). In aspects, the on-premises edge 110 enables cloud integration with a radio access network (RAN). The switch 114 and the edge servers 116 process incoming data traffic and outgoing data traffic. The edge servers 116 execute the near real-time RAN intelligent controller 112. In aspects, the on-premises edge 110 is generally geographically remote from the cloud datacenters associated with the core network and cloud services. The remote site is in geographic proximity to the base station 102. For example, the proximity in the present disclosure may be within about a few kilometers. In aspects, the upstream data traffic corresponds to data flowing from at least the base station 102 to cloud servers 124. Similarly, the downstream data traffic corresponds to data flowing from the cloud 120 (service) to the cell tower. In further aspects, regional datacenters that support the cloud 120 may serve a broad geographic area and the cloud server resources (including processing units and memory) may be more robust and powerful than the edge servers 116.

The cloud 120 includes cloud servers 124 and other distributed resources for providing resource-intensive service operations. In aspects, one or more servers in the cloud 120 may be at a central location in a cloud RAN infrastructure (e.g., O-CU in O-RAN). In this case, the central locations may be hundreds of kilometers from the base station 102. In aspects, the cloud 120 includes non-real-time RAN intelligence controller 122 (RIC non-RT). The cloud servers 124, which are even further removed from the IoT device 104, may offer a reduced level of real-time (e.g., non-real-time) processing in response to captured user data.

In aspects, the cloud 120 includes a network edge (not shown in FIG. 1). The network edge includes servers that are geographically located at a regional datacenter of a private cloud service. For example, the regional datacenter may be about tens of kilometers from the base station 102.

The deep reinforcement-based learning server 130 connects to the near real-time RAN intelligent controller 112 in the on-premises edge 110. The deep reinforcement-based learning server 130 includes near real-time DRL machine learning model 132. The deep reinforcement-based learning server 130 requests for and receives network state data associated with the base station 102 through the near real-time RAN intelligent controller 112. Given the network state data the deep reinforcement-based learning server 130 determines a set of control parameters for updating operations of the base station 102. In particular, the deep reinforcement-based learning server 130 uses the near real-time DRL machine learning model 132 to determine control parameter values as action data based on a combination including the network state data and targeted conditions as indicated by reward data. In aspects, the near real-time DRL machine learning model 132 includes a deep convolutional neural network with a plurality of layers to predict control parameter values.

According to reinforcement-based learning algorithms, the deep reinforcement-based learning server 130 with the near real-time DRL machine learning model 132 represents an agent (italicized to indicate as among term used in reinforcement-based learning: agent, state, reward data, and action). The network state data represents a current state of the network at the base station 102. The targeted conditions represent reward data. The determined control parameter values represent an action. The operation of the base station 102 based on the determined control parameter values represent an environment. The near real-time DRL machine learning model 132 is trained based on deep learning to determine and/or predict the set of control parameter values based on the given current network state data by maximizing target conditions. As such, the deep reinforcement-based learning server 130 iteratively determine a new set of control parameter values based on the current network state data as trial-and-error operations.

In aspects, the deep reinforcement-based learning server 130 determines a set of control parameter values for updating the control parameters at the base station 102 in real-time or in near real-time. In some aspects, periodic iterations of updating in real-time or in near real-time the control parameters as a performance benchmark take place in every 10 milliseconds.

Additionally, or alternatively, the deep reinforcement-based learning server 130 includes non-real-time DRL machine learning model 134 and connects to the non-real-time RAN intelligence controller 122 (RIC non-RT). The deep reinforcement-based learning server 130 determines a new set of control parameter values based on the current network state data in a way that is similar to the real-time or near real-time operations as detailed above. In some aspect, periodic iterations of updating in non-real-time the control parameters as a performance benchmark take place up to every second.

As will be appreciated, the various methods, devices, applications, features, etc., described with respect to FIG. 1 are not intended to limit the system 100 to being performed by the particular applications and features described. Accordingly, additional controller configurations may be used to practice the methods and systems herein and/or features and applications described may be excluded without departing from the methods and systems disclosed herein.

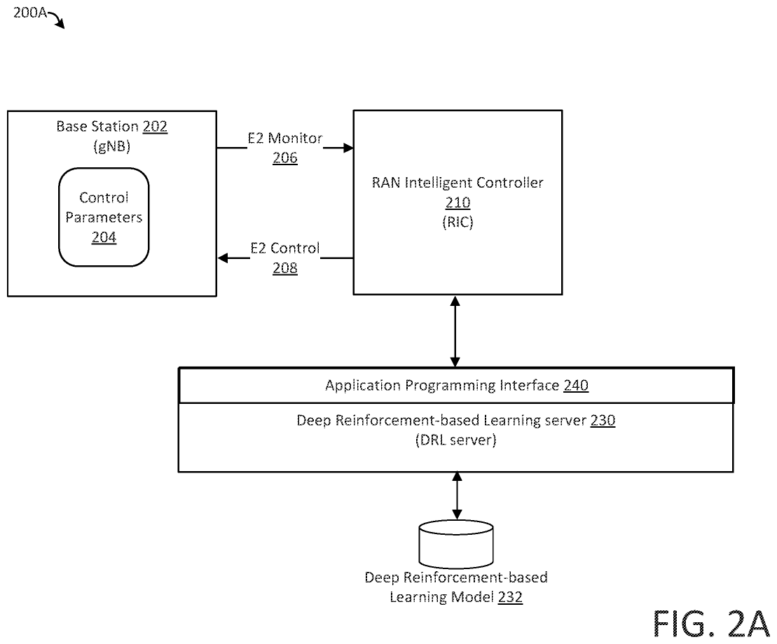

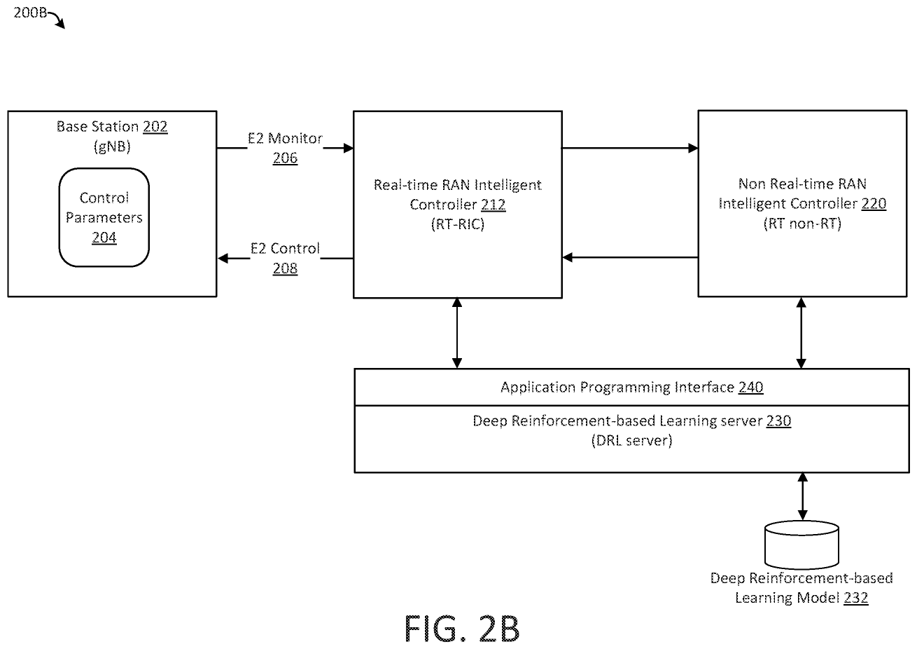

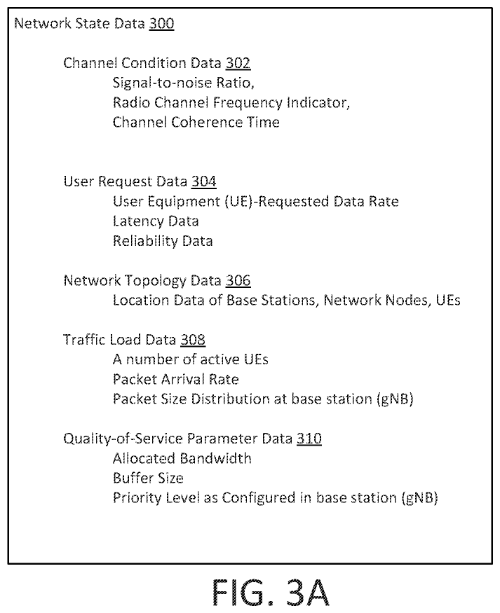

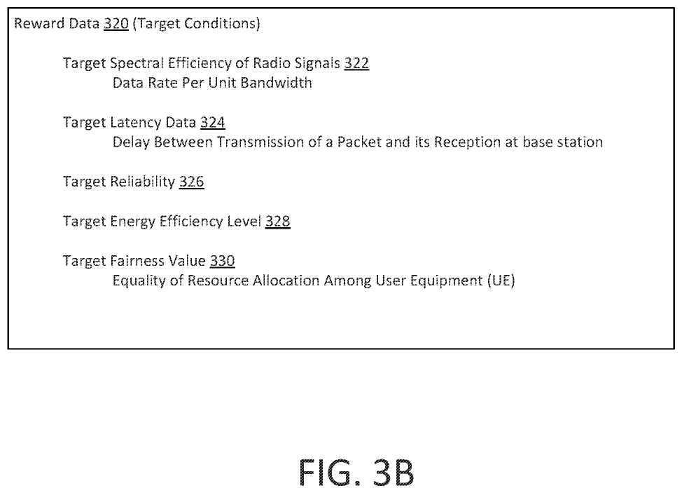

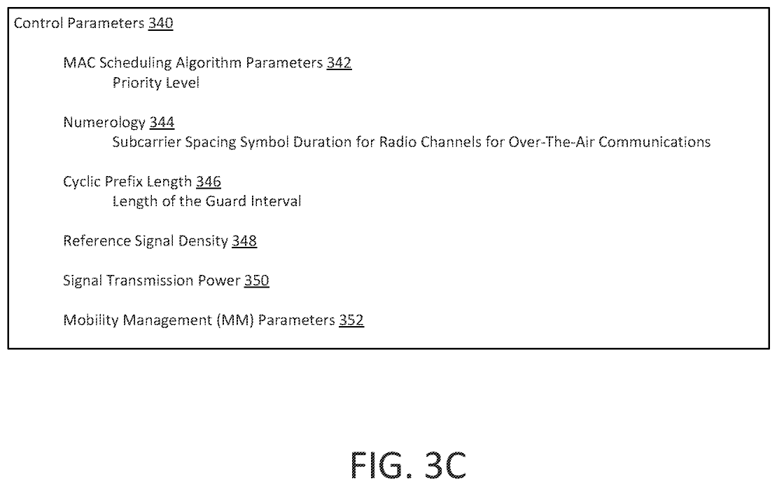

FIGS. 2A-2B illustrate example systems for monitoring states and dynamically updating control parameters associated with base station using a deep reinforcement-based learning in accordance with aspects of the present disclosure. In particular, FIG. 2A illustrates an example system for monitoring states and dynamically updating control parameters associated with base station using a deep reinforcement-based learning through a RAN intelligent controller in accordance with aspects of the present disclosure. An example system 200A includes base station 202, RAN intelligent controller 210 (RIC) and deep reinforcement-based learning server 230. In aspects, the base station 202 (e.g., gNB) includes a set of control parameters 204 for adjusting operations of the base station 202. Examples of the control parameters 204 include MAC scheduling algorithm parameters 342, numerology 344, cyclic prefix length 346, reference signal density 348, signal transmission power 350, mobility management (MM) parameters 352, and the like (as shown in FIG. 3C).

The RAN intelligent controller 210 (RIC) receives and processes data traffic receiving from the base station 202. The RAN intelligent controller 210 further receives status data associated with the current state of the base station 202.

The deep reinforcement-based learning server 130 communicates with the RAN intelligent controller 210. In aspects, the deep reinforcement-based learning server 130 periodically requests the RAN intelligent controller 210 to request for and receive network state data associated with the base station 202. In aspects, in response to the request from the deep reinforcement-based learning server 230 for network state data, the RAN intelligent controller 210 uses a communication interface (e.g., E2 Control interface 208 of the O-RAN) to request network state data from the base station 202. In some other aspects, the RAN intelligent controller 210 may retrieve the network state data from a storage (e.g., a cache memory). The RAN intelligent controller 210 may periodically retrieve the network state data regardless of receiving a request for the network state data from the deep reinforcement-based learning server 230 or any other entity in the system 200A.

In aspects, the network state data represents the current condition associated with operating the base station 202. In some aspects, in response to receiving the request for network state data, the base station 202 retrieves the network state data within the base station 202 and transmits the network to the RAN intelligent controller 210 using a monitoring protocol (e.g., the E2 Monitor interface 206 of the O-RAN). Given the network state data as the current state, the RAN intelligent controller 210 transmits the network state data to the deep reinforcement-based learning server 230. In some other aspects, the RAN intelligent controller 210 may periodically receive the network state data and store in a cache storage regardless of receiving the request for network state data from the deep reinforcement-based learning server 230. The RAN intelligent controller 210 may retrieve the cached network state data and sent the retrieved network state data to the deep reinforcement-based learning server 230.

In aspects, the deep reinforcement-based learning server 230 uses a deep reinforcement-based learning model 232 (DRL model). The deep reinforcement-based learning model 232 may include a deep convolutional neural network with a plurality of layers of nodes. The deep reinforcement-based learning model 232 (e.g., a combination of the near real-time DRL machine learning model 132 and/or the non-real-time DRL machine learning model 134 as shown in FIG. 1), after being trained, uses the network state data as state data and determines a set of control parameters as action according to target network condition as reward data.

In some aspects, data communication between the deep reinforcement-based learning server 230 and the RAN intelligent controller 210 uses an application programming interface 240 (API) with commands. Examples of the API may include a first request command for network state data and a second request command for modifying control parameter values at the base station 202 as specified by the deep reinforcement-based learning server 230. In aspects, the first request command includes an identifier of the base station 202 as input and a set of network state data associated with the base station 202 as an output. The second request command includes an identifier of the base station 202 and one or more pairs of control parameter names and values as input and a completion status of receiving the second request as an output.

As will be appreciated, the various methods, devices, applications, features, etc., described with respect to FIG. 2A are not intended to limit the system 200A to being performed by the particular applications and features described. Accordingly, additional controller configurations may be used to practice the methods and systems herein and/or features and applications described may be excluded without departing from the methods and systems disclosed herein.

FIG. 2B illustrates an example system for monitoring states and dynamically updating control parameters associated with base station using a deep reinforcement-based learning through a RAN intelligent controller in accordance with aspects of the present disclosure. An example system 200 includes base station 202, real-time RAN intelligent controller 212 (RT-RIC), non-real-time RAN intelligent controller 220 (RT non-RT), and deep reinforcement-based learning server 230. In aspects, the base station 202 (e.g., gNB) includes a set of control parameters 204 for adjusting operations of the base station 202. Examples of the control parameters 204 include

The real-time RAN intelligent controller 212 (RT-RIC) receives and processes in real-time a data traffic receiving from the base station 202. The real-time RAN intelligent controller 212 further receives status data associated with the current state of the base station 202. The non-real-time RAN intelligent controller 220 (RT non-RT) connects to the real-time RAN intelligent controller 212. The non-real-time RAN intelligent controller 220 receives the data traffic from the real-time RAN intelligent controller 212 for further processing the data traffic in non-real-time operations.

The deep reinforcement-based learning server 130 communicates with either or both of the real-time RAN intelligent controller 212 and the non-real-time RAN intelligent controller 220. In aspects, the deep reinforcement-based learning server 130 periodically requests the real-time RAN intelligent controller 212 to inquire and receive network state data from the base station 202. In response to the request from the deep reinforcement-based learning server 230 for network state data, the real-time RAN intelligent controller 212 uses a communication interface (e.g., E2 Control interface 208 of the O-RAN) to request network state data from the base station 202.

In aspects, the network state data represents the current condition associated with operating the base station 202. In response to receiving the request for network state data, the base station 202 retrieves the network state data within the base station 202 and transmits the network to the real-time RAN intelligent controller 212 using a monitoring protocol (e.g., the E2 Monitor interface 206 of the O-RAN). Given the network state data as the current state, the real-time RAN intelligent controller 212 transmits the network state data to the deep reinforcement-based learning server 230.

In aspects, the deep reinforcement-based learning server 230 uses a deep reinforcement-based learning model 232 (DRL model). The deep reinforcement-based learning model 232 may include a deep convolutional neural network with a plurality of layers of nodes. The deep reinforcement-based learning model 232 (e.g., a combination of the near real-time DRL machine learning model 132 and the non-real-time DRL machine learning model 134 as shown in FIG. 1), after being trained, uses the network state data as state data and determines a set of control parameters as action according to target network condition as reward data.

In some aspects, the control parameters include real-time control parameters and non-real-time control parameters. The deep reinforcement-based learning server 230 determines values for real-time control parameters and transmits the values to the real-time RAN intelligent controller 212. After receiving the determined real-time control parameter values, the real-time RAN intelligent controller 212 transmits the determined real-time control parameter values to the base station 202 using the E2 Control interface 208.

Additionally, or alternatively, the deep reinforcement-based learning server 230 periodically (but less frequently) request the non-real-time RAN intelligent controller 220 to request the base station 202 through the real-time RAN intelligent controller 212 for the network state data. The deep reinforcement-based learning server 230 determines values for non-real-time control parameters and transmits the values to the non-real-time RAN intelligent controller 220. After receiving the determined non-real-time control parameter values, the non-real-time RAN intelligent controller 220 transmits the determined non-real-time control parameter values to the base station 202 through the real-time RAN intelligent controller 212.

In some aspects, data communication between the deep reinforcement-based learning server 230 and the real-time RAN intelligent controller 212 and the non-real-time RAN intelligent controller 220 uses an application programming interface 240 (API) with commands. Examples of the API may include a first request command for network state data and a second request command for communicating with the base station 202 to update control parameter values as specified by the deep reinforcement-based learning server 230. In aspects, the first request command includes an identifier of the base station 202 as input and a set of network state data associated with the base station 202 as an output. The second request command includes an identifier of the base station 202 and one or more pairs of control parameter names and values as input and a completion status of receiving the second request as an output.

As will be appreciated, the various methods, devices, applications, features, etc., described with respect to FIG. 2B are not intended to limit the system 200B to being performed by the particular applications and features described. Accordingly, additional controller configurations may be used to practice the methods and systems herein and/or features and applications described may be excluded without departing from the methods and systems disclosed herein.

FIGS. 3A-C illustrate examples of types of data in accordance with the aspects of the present disclosure. FIG. 3A illustrates an example of network state data 300 in accordance with aspects of the present disclosure. The network state data 300 indicates a state of network operations at a base station (e.g., the base station 102 as shown in FIG. 1). In aspects, the network state data 300 includes channel condition data 302, user request data 304, network topology data 306, traffic load data 308, quality-of-service parameter data 310, and the like. The base station periodically measures and collects the network state data 300.

In aspects, the channel condition data 302 includes data that indicate conditions of a data communication channel. Examples of the channel condition data 302 includes signal-to-noise ratio, radio channel frequency indicator, channel coherence time, and the like. The user request data 304 indicates conditions associated with data communication as requested by user equipment (e.g., the IoT device 104 as shown in FIG. 1). Examples of the user request data 304 include user equipment (UE)-requested data rate for communication, latency data, reliability data (e.g., a data drop rate, a data integrity level, and the like), and the like.

In aspects, the network topology data 306 indicates information associated with how the network is geographically implemented. Examples of the network topology data 306 include location data associated with base stations, network nodes, user equipment (e.g., the IoT device), and the like.

The traffic load data 308 indicates a load level of data traffic at the base station. Examples of the traffic load data 308 include a number of active user equipment (e.g., the IoT devices) connected to the base station, a packet arrival rate, and distribution data of packet sizes at the base station. The quality-of-service parameter data 310 indicates a level of quality of service being performed at the base station. Examples of the quality-of-service parameter data 310 include a bandwidth that is allocated to respective data communication channels or the aggregates at the base station, a size of a data buffer used for retransmission of data packets at the base station in case of service interruption, and a priority level of processing data traffic among a plurality of data channels at the base station.

FIG. 3B illustrates an example of reward data in accordance with aspects of the present disclosure. Example reward data 320 indicates a set of target conditions as reward in the deep reinforcement-based learning operations by the deep reinforcement-based learning server using the deep reinforcement-based learning model (e.g., the deep reinforcement-based learning server 230 using the deep reinforcement-based learning model 232 as shown in FIG. 2). In aspects, the deep reinforcement-based learning model 232 determines a set of control parameters as action by increasing/improving values associated with the reward data 320. In aspects, the reward data 320 include target spectral efficiency of radio signals 322, target latency data 324, target reliability 326, target energy efficiency level 328, target fairness value 330, and the like.

The target spectral efficiency of radio signals 322 indicates a targeted value of spectral efficiency associated with radio signals transmitted at the base station. Examples of the target spectral efficiency include a data rate per unit bandwidth, and the like. The target latency data 324 indicates a targeted value of latency associated with data communication at the base station. Examples of the target latency data 324 include a delay time between transmission of a packet by an IoT device and its reception at the base station. The target reliability 326 indicates a targeted level of reliability associated with data communication at the base station. Examples of the target reliability 326 includes a mean time between failure, a data loss, and the like. The target energy efficiency level 328 indicates a targeted level of energy efficiency at the base station. The target fairness value 330 indicates a targeted value that indicates a fairness of resources allocated to respective user equipment (e.g., the IoT devices) in communication sessions with the base station. Examples of the target fairness value 330 includes a level of equality of resource allocations among the user equipment.

In aspects, the respective data in the reward data 320 may be improved by adjusting one or more control parameter values. Values of distinct control parameters cause different types of reward data 320 to change. The deep reinforcement-based learning model, after being trained through deep learning, determines a set of parameter values (“action”) based on the given network state data (“state” of the environment) by maximizing values of the respective types of the reward data 320.

FIG. 3C illustrates an example of control parameters in accordance with aspects of the present disclosure. Example control parameters 340 describes types of controls that may be imposed on the base station. The base station uses the cell tower to operate cellular wireless communications with user equipment (e.g., the IoT devices) according to the values set in the control parameters. In aspects, the control parameters 340 includes MAC scheduling algorithm parameters 342, numerology 344, cyclic prefix length 346, reference signal density 348, signal transmission power 350, mobility management (MM) parameters 352, and the like.

The MAC scheduling algorithm parameters 342 specifies and assigns bandwidth to user equipment (e.g., the IoT devices) in uplink and downlink communication channels. In aspects, the base station determines resource allocations and quality-of-service to the respective user equipment. The numerology 344 specifies spacing between subcarriers in the frequency domain of radio channels for cellular wireless communication. Examples of a numerology include subcarrier spacings between 15 kHz and 240 kHz. The base station may use a plurality of numerologies to accommodate data traffic over a range of carrier frequencies.

The cyclic prefix length 346 specifies a length of a cyclic prefix for adjusting a delay of communicating a symbol in data traffic with user equipment in a cell with multipath signals at the base station. The cyclic prefix length 346 indicates a length of the guard interval associated with a decoding window for recovering lost part of the symbol and to avoid inter-symbol interference in cellular wireless communication. A value of the cyclic prefix length 346 changes quality-of-service of data communication at the base station.

The reference signal density 348 specifies density in either or both of the time domain (e.g., time density) and the frequency domain (e.g., frequency density) of a reference radio signal used for cellular wireless communications at the base station. In aspects, settings of the reference signal density may change a level of energy efficiency at the base station.

The signal transmission power 350 specifies a level of power for transmitting radio signals at the base station. Parameter values associated with the signal transmission power 350 is associated with power efficiency of the base station. The mobility management (MM) parameters 352 specifies cell selection and reselection at the base stations, hand overs associated with user equipment, tracking user equipment in idle mode, notifying the user equipment in connected mode, and the like.

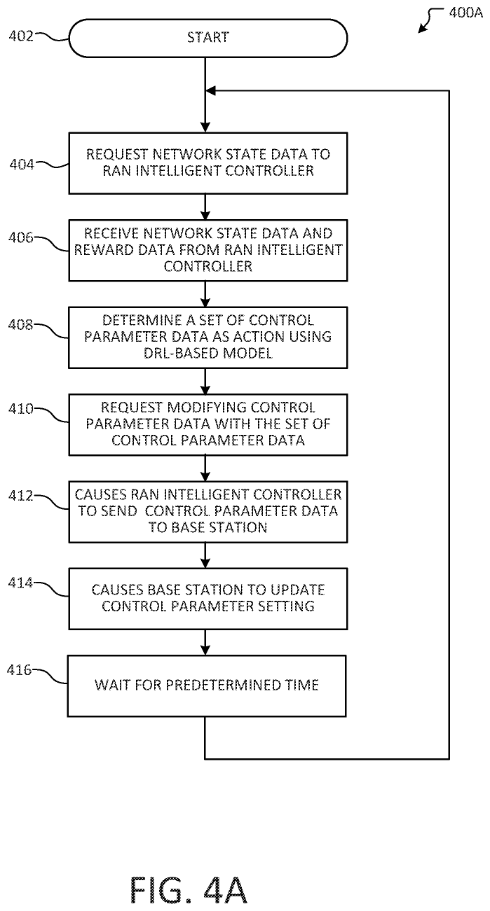

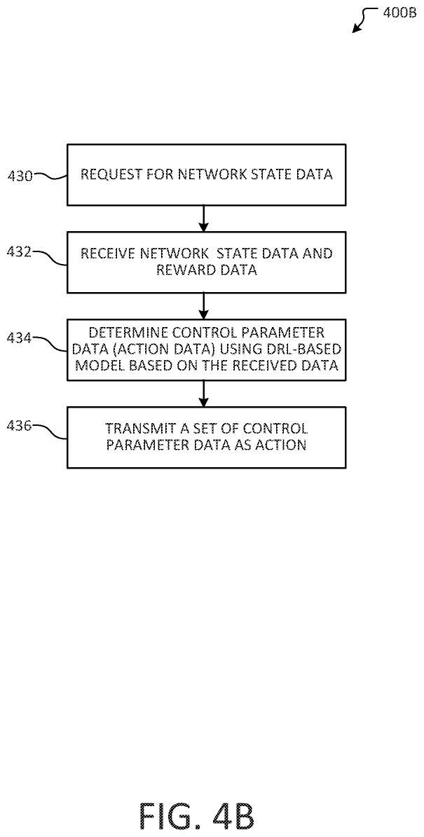

FIGS. 4A-4B illustrate examples of methods of updating control parameter values of a base station in accordance with aspects of the present disclosure.

FIG. 4A illustrates an example of a method for monitoring states and dynamically updating control parameters associated with a base station using a deep reinforcement-based learning in accordance with aspects of the present disclosure. A general order of the operations for the method 400A is shown in FIG. 4A. Generally, the method 400A begins with start operation 402. The method 400A may include more or fewer steps or may arrange the order of the steps differently than those shown in FIG. 4A. The method 400A can be executed as a set of computer-executable instructions executed by a computer system and encoded or stored on a computer readable medium. Further, the method 400A can be performed by gates or circuits associated with a processor, an ASIC, an FPGA, a SOC or other hardware device. Hereinafter, the method 400A shall be explained with reference to the systems, components, devices, modules, software, data structures, data characteristic representations, signaling diagrams, methods, etc., described in conjunction with FIGS. 1, 2, 3A, 3B, 3C, 4B, 5, 6, and 7.

Following start operation 402, the method 400A begins with request operation 404, in which a request for sending network state data is transmitted by a deep reinforcement-based learning server. In aspects, the request is transmitted to a RAN intelligent controller (e.g., the RAN intelligent controller 210 shown in FIG. 2A; either real-time RAN intelligent controller 212 (e.g., RT RIC) or non-real-time RAN intelligent controller 220 (e.g., RIC non-RT) as shown in FIG. 2B). In aspects, the request is sent periodically to the RAN intelligent controller according to a predetermined time period. For example, the request is sent by the deep reinforcement-based learning server to the real-time RAN intelligence controller in every predetermined time period of 10 milliseconds. In some other aspects, the request is sent by the deep reinforcement-based learning server to the non-real-time RAN intelligent controller at every predetermined time period of up to every second.

Additionally, or alternatively, the request operation 404 is followed by causing to request operation (not shown in FIG. 4A). The causing to request operation causes, in response to the request operation 404, the RAN intelligent controller to send a request to the base station for network state data. In aspects, the RAN intelligent controller uses the E2 control communication protocol (according to O-RAN) to request the base station to send the network state data.

Additionally, or alternatively, the causing to request operation is further followed by causing to receive operation (not shown in FIG. 4A). The causing to receiving operation causes the RAN intelligent controller to receive network state data. In aspects, the RAN intelligent controller receives the network state data from the base station using the E2 Monitor protocol. In some other aspects, the RAN intelligent controller periodically receives network state data and caches in a memory regardless of receiving the request operation 404. The RIC non-RT receives the network state data from the base station via the RT-RIC. The RIC non-RT may cache the received network data in a memory.

Receive operation 406 receives, by the deep reinforcement-based learning server, the network state data from the RT-RIC and the RIC non-RT. In aspects, the network state data indicates a state of operation at the base station. The network state data may include channel condition data, user request data, network topology data, traffic load data, quality-of-service parameter data, and the like (e.g., the network state data 300 as shown in FIG. 3A). In some aspects, the deep reinforcement-based learning server receives the network state data, which the RAN intelligent controller retrieves from cached network state data in a memory.

Determine operation 408 determines, in response to the received network state data, a set of control parameter data using a deep reinforcement-based learning model (e.g., the deep reinforcement-based learning model 232 as shown in FIG. 2). In aspects, the determine operation 408 determines the set of control parameter as an action (e.g., control parameters 340 as shown in FIG. 3C) according to a deep reinforcement-based learning. The received network state data corresponds to a state (e.g., the network state data 300 as shown in FIG. 3A). The deep reinforcement-based learning model is trained to maximize a probability of achieving a set of target conditions as a reward (e.g., the reward data 320 as shown in FIG. 3B).

In request modifying control parameter data operation 410, the set of control parameter data is transmitted to the RAN intelligent controller with a request command to modify control parameters in the base station. In aspects, the set of control parameter data include a real-time subset that corresponds to updating parameters the base station in real-time. The set of control parameter may include a non-real-time subset that corresponds to updating parameters in the base station in non-real-time. The request modifying control parameter data operation 410 transmits the request with the real-time subset data to the RT-RIC. Additionally, or alternatively, the request modifying control parameter data operation 410 transmits the non-real subset data to the RIC non-RT.

Cause to send operation 412 causes the RAN intelligent controller to send the set of control parameter data to the base station. In aspects, the causing to send operation 412 causes the RIC non-RT to send the non-real-time subset of the set of control parameter data to the base station through the RT-RIC. In some other aspects, the RT-RIC sends the set of control parameter data to the base station using the “E2 Control” interface of the O-RAN. In some aspects, the cause to send operation 412 may cause the RT-RIC to transmit the set of control parameter data to a plurality of base stations. Additionally, or alternatively, the cause to send operation 412 causes the RAN intelligent controller to send the set of control parameter data to the based station not directly but through one or more distinct servers. In aspects, the cause to send operation 412 further results in the based station to receive the set of control parameter data.

Cause to update operation 414 causes the base station to dynamically update control parameter setting according to the received set of control parameter data. In aspects, the causing to update operation 414 causes the plurality of base stations that have received the set of control parameter data from the RAN intelligent controller.

Wait operation 416 waits for a predetermined time before proceeding to the transmit request operation 404. In aspects, the predetermined time may depend on a type of control parameter data to update. For example, the predetermined time to periodically updating control parameter setting in real-time or in near real-time may be substantially close to 10 milliseconds. Additionally, or alternatively, the predetermined time to periodically updating control parameter setting in non-real-time may be substantially close to one second.

As should be appreciated, operations 402-416 are described for purposes of illustrating the present methods and systems and are not intended to limit the disclosure to a particular sequence of steps, e.g., steps may be performed in different order, additional steps may be performed, and disclosed steps may be excluded without departing from the present disclosure.

FIG. 4B illustrates an example of a method for determining control parameter data using a deep reinforcement-based learning model in accordance with aspects of the present disclosure. A general order of the operations for the method 400B is shown in FIG. 4B. Generally, the method 400B begins with request operation 430 and ends with transmit operation 436. The method 400B may include more or fewer steps or may arrange the order of the steps differently than those shown in FIG. 4B. The method 400B can be executed as a set of computer-executable instructions executed by a computer system and encoded or stored on a computer readable medium. Further, the method 400B can be performed by gates or circuits associated with a processor, an ASIC, an FPGA, a SOC or other hardware device. Hereinafter, the method 400B shall be explained with reference to the systems, components, devices, modules, software, data structures, data characteristic representations, signaling diagrams, methods, etc., described in conjunction with FIGS. 1, 2A, 2B, 3A, 3B, 3C, 4A, 5, 6, and 7.

The method 400B begins with the request operation 430, in which a set of network state data is requested. In aspects, the request operation 430 is performed by a deep reinforcement-based learning server (e.g., the deep reinforcement-based learning server 230 as shown in FIG. 2). In some aspects, the request is sent to RIC. (e.g., the RAN intelligent controller 210 as shown in FIG. 2.) The RT RIC then send the request as a control command to the base station (e.g., the base station 202 as shown in FIG. 2) using the E2 Control interface of O-RAN.

In receive operation 432, network state data is received from the base station. In aspects, the deep reinforcement-based learning server receives network state associated with the base station from the RT RIC. The network state data includes values of various types of network state according to operations in the base station.

In determine operation 434, a set of control parameter data (e.g., a set of control parameter data) for updating settings at the base station is determined by the deep reinforcement-based learning server. In aspects, the deep reinforcement-based learning server uses a deep reinforcement-based learning model to determine the set of control parameter data. The deep reinforcement-based learning model may include a deep neural network, which includes a plurality of layers for predicting values the set of control parameter data based on the network state data as input. In some aspects, the deep reinforcement-based learning model is trained based on reward data (e.g., target conditions). Furthermore, accuracy of the set of control parameter data improves as the deep reinforcement-based learning model iteratively generates the set of control parameter based on given network state data.

In transmit operation 436, the determined set of control parameter data is transmitted from the deep reinforcement-based learning server to the RT RIC. In aspects, the transmit operation 436 cause the RT-RIC generate a control command to update control parameter setting at the radio station according to the set of control parameter data. In aspects, the determined set of control parameter data represent action in the deep reinforcement-based learning. The method 400B ends with the transmit operation 436.

As should be appreciated, operations 430-436 are described for purposes of illustrating the present methods and systems and are not intended to limit the disclosure to a particular sequence of steps, e.g., steps may be performed in different order, additional steps may be performed, and disclosed steps may be excluded without departing from the present disclosure.

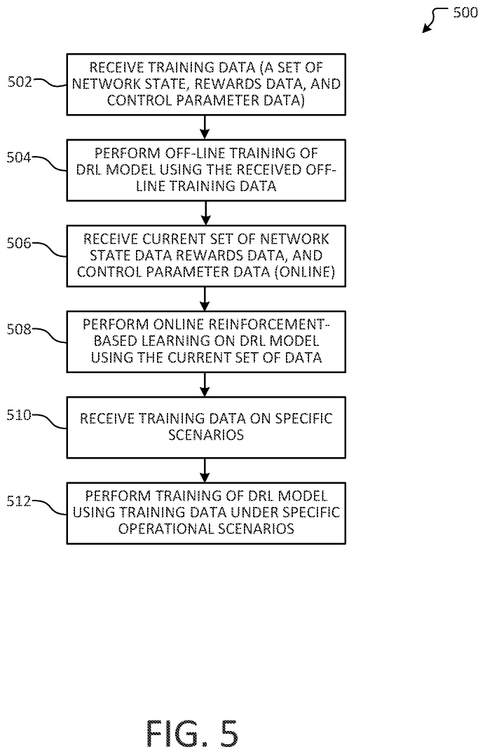

FIG. 5 illustrates an example of a method for training a deep reinforcement-based learning model in accordance with aspects of the present disclosure. A general order of the operations for the method 500 is shown in FIG. 5. Generally, the method 500 begins with receive training data operation 502 and ends with perform training using specific scenario operation 512. The method 500 may include more or fewer steps or may arrange the order of the steps differently than those shown in FIG. 5. The method 500 can be executed as a set of computer-executable instructions executed by a computer system and encoded or stored on a computer readable medium. Further, the method 500 can be performed by gates or circuits associated with a processor, an ASIC, an FPGA, a SOC or other hardware device. Hereinafter, the method 500 shall be explained with reference to the systems, components, devices, modules, software, data structures, data characteristic representations, signaling diagrams, methods, etc., described in conjunction with FIGS. 1, 2A, 2B, 3A, 3B, 3C, 4A, 4B, 6, and 7.

In aspects, training of the deep reinforcement-based learning model takes place in at last the following three occasions. A first occasion includes training the deep reinforcement-based learning model while the model is offline. A second occasion includes training the deep reinforcement-based learning model as a reinforcement-based learning using actual network state data while the model is in use. A third occasions includes training the deep reinforcement-based learning model to support a specific scenario of operations.

The method 500 begins with the receive training data operation 502, in which training data for offline training of the deep reinforcement-based learning model is received. In aspects, the training data includes a set of network state data, rewards data, and control parameter data. IN aspects, the rewards data corresponds to a set of target conditions.

In perform offline training operation 504, offline training of the deep reinforcement-based learning model is performed using the received offline training data. The offline training includes using the network state data as truthful state data, target network condition as rewards data, and a truthful set of control parameter data as action for training.

In receive the current set of network state data operation 506, the current set of network state data associated with the base station is received. In aspects, the current set of network state data represent actual network state data associated with the base station in operation. The current set of network state data may be received the deep reinforcement-based learning server from the base station through the RT RIC.

In perform online reinforcement-based learning operation 508, learning based on online deep reinforcement is performed by the deep reinforcement-based learning server. In aspects, the deep reinforcement-based learning server trains an online, deep reinforcement-based learning model. In some aspects, the deep reinforcement-based learning improves accuracy of the control parameter data through processing iterations of determining action based on state according to rewards data.

In receive training data on specific scenarios operation 510, training data that focuses on specific scenarios of determining control parameter data is received. In aspects, the specific scenarios may include improving specific types of rewards. Examples of the specific scenarios may include improving energy efficiency of operating the base station, improving spectral efficiency of radio signals at the base station, and the like.

In perform training using a specific scenario operation 512, the deep reinforcement-based learning model is trained using the received training data with a focus on a specific scenario. In some aspects, the training of the deep reinforcement-based learning model in the specific may take place while the deep reinforcement-based learning model is offline. Additionally, or alternatively, the training of the deep reinforcement-based learning model may take place while the deep reinforcement-based learning model is online.

As should be appreciated, operations 502-512 are described for purposes of illustrating the present methods and systems and are not intended to limit the disclosure to a particular sequence of steps, e.g., steps may be performed in different order, additional steps may be performed, and disclosed steps may be excluded without departing from the present disclosure.

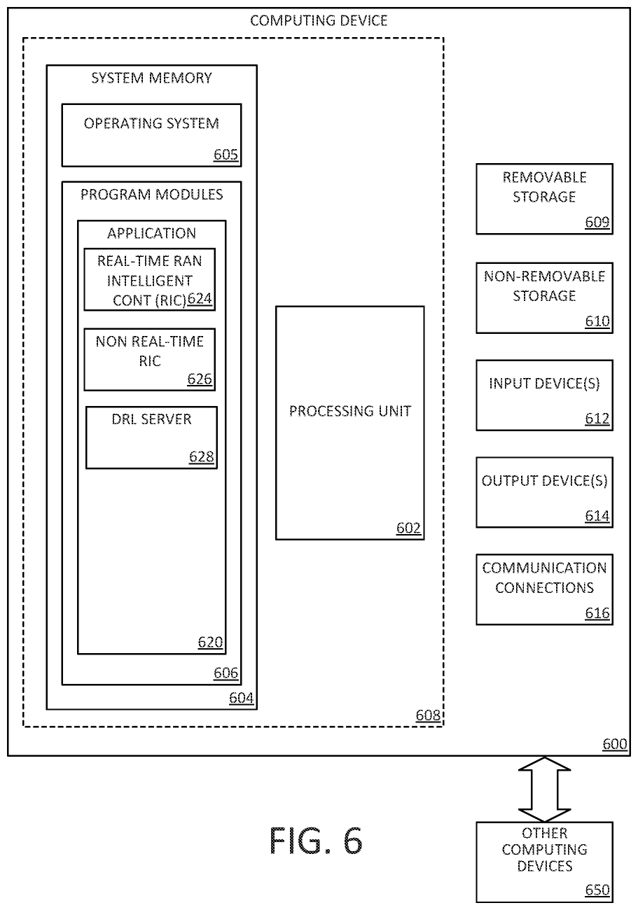

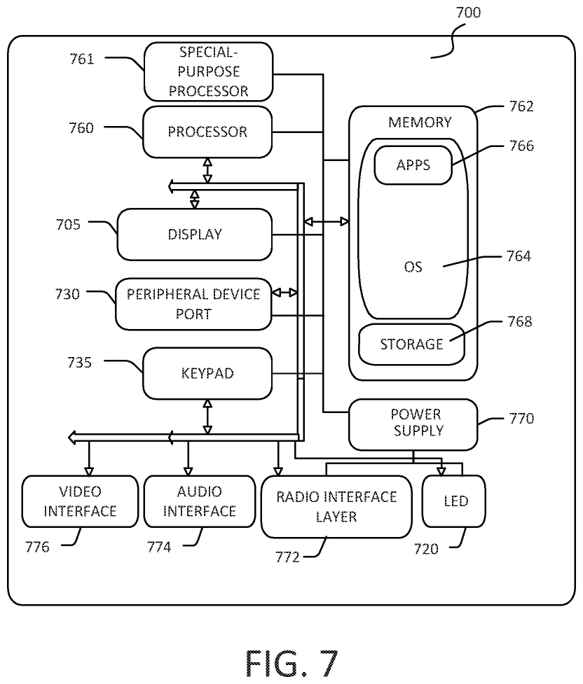

FIGS. 6-7 and the associated descriptions provide a discussion of a variety of operating environments in which aspects of the disclosure may be practiced. However, the devices and systems illustrated and discussed with respect to FIGS. 6-7 are for purposes of example and illustration and are not limiting of a vast number of computing device configurations that may be utilized for practicing aspects of the disclosure, described herein.

FIG. 6 is a block diagram illustrating example physical components of a computing device with which aspects of the disclosure may be practiced. FIG. 6 is a block diagram illustrating physical components (e.g., hardware) of a computing device 600 with which aspects of the disclosure may be practiced. The computing device components described below may be suitable for the computing devices described above, including one or more devices associated with the deep reinforcement-based learning server 130 discussed above with respect to FIG. 1. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories.

The system memory 604 may include an operating system 605 and one or more program modules 606 suitable for running software application 620, such as one or more components supported by the systems described herein. As examples, system memory 604 may store program instructions associated with real-time RAN intelligent controller (RT RIC) 624, non-real-time RAN intelligent controller (RIC Non-RT) 626, and the deep reinforcement-based learning (DRL) server 628. The operating system 605, for example, may be suitable for controlling the operation of the computing device 600.

Furthermore, embodiments of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the at least one processing unit 602, the program modules 606 (e.g., software application 620) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

The computing device 600 may also have one or more input device(s) 612 such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of suitable communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

FIG. 7 is a simplified block diagram of a computing device with which aspects of the present disclosure may be practiced. FIG. 7 illustrates a system 700 that may, for example, be a mobile computing device, such as a mobile telephone, a smart phone, wearable computer (such as a smart watch), a tablet computer, a laptop computer, and the like, with which embodiments of the disclosure may be practiced. In one embodiment, the system 700 is implemented as a “smart phone” capable of running one or more applications (e.g., browser, e-mail, calendaring, contact managers, messaging clients, games, and media clients/players). In some aspects, the system 700 is integrated as a computing device, such as an integrated personal digital assistant (PDA) and wireless phone.

In a basic configuration, such a mobile computing device is a handheld computer having both input elements and output elements. The system 700 typically includes a display 705 and one or more input buttons that allow the user to enter information into the system 700. The display 705 may also function as an input device (e.g., a touch screen display).

If included, an optional side input element allows further user input. For example, the side input element may be a rotary switch, a button, or any other type of manual input element. In alternative aspects, system 700 may incorporate more or less input elements. For example, the display 705 may not be a touch screen in some embodiments. In another example, an optional keypad 735 may also be included, which may be a physical keypad or a “soft” keypad generated on the touch screen display.

In various embodiments, the output elements include the display 705 for showing a graphical user interface (GUI), a visual indicator 720 (e.g., a light emitting diode), and/or an audio transducer 725 (e.g., a speaker). In some aspects, a vibration transducer is included for providing the user with tactile feedback. In yet another aspect, input and/or output ports are included, such as an audio input (e.g., a microphone jack), an audio output (e.g., a headphone jack), and a video output (e.g., a HDMI port) for sending signals to or receiving signals from an external device.

One or more application programs 766 may be loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. The system 700 also includes a non-volatile storage area 768 within the memory 762. The non-volatile storage area 768 may be used to store persistent information that should not be lost if the system 700 is powered down. The application programs 766 may use and store information in the non-volatile storage area 768, such as e-mail or other messages used by an e-mail application, and the like. A synchronization application (not shown) also resides on the system 700 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the system 700 described herein.

The system 700 has a power supply 770, which may be implemented as one or more batteries. The power supply 770 might further include an external power source, such as an AC adapter or a powered docking cradle that supplements or recharges the batteries.

The system 700 may also include a radio interface layer 772 that performs the function of transmitting and receiving radio frequency communications. The radio interface layer 772 facilitates wireless connectivity between the system 700 and the “outside world,” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 720 may be used to provide visual notifications, and/or an audio interface 774 may be used for producing audible notifications via the audio transducer 725. In the illustrated embodiment, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with embodiments of the present disclosure, the microphone may also serve as an audio sensor to facilitate control of notifications, as will be described below. The system 700 may further include a video interface 776 that enables an operation of an on-board camera 730 to record still images, video stream, and the like.

It will be appreciated that system 700 may have additional features or functionality. For example, system 700 may also include additional data storage devices (removable and/or non-removable) such as, magnetic disks, optical disks, or tape. Such additional storage is illustrated in FIG. 7 by the non-volatile storage area 768.

Data/information generated or captured and stored via the system 700 may be stored locally, as described above, or the data may be stored on any number of storage media that may be accessed by the device via the radio interface layer 772 or via a wired connection between the system 700 and a separate computing device associated with the system 700, for example, a server computer in a distributed computing network, such as the Internet. As should be appreciated, such data/information may be accessed via the radio interface layer 772 or via a distributed computing network. Similarly, such data/information may be readily transferred between computing devices for storage and use according to any of a variety of data/information transfer and storage means, including electronic mail and collaborative data/information sharing systems.

It will be appreciated that the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

The present disclosure relates to systems and methods for determining and updating according control parameter data associated with a base station according to at least the examples provided in the sections below. As will be understood from the foregoing disclosure, one aspect of technology relates to a computer-implemented method. The method comprises obtaining network state data by transmitting, according to a predetermined time interval, a request to a radio access network intelligent controller for network state data associated with a base station; determine, based on the network state data, a set of control parameter data using a deep reinforcement-based learning model, wherein the deep reinforcement-based learning model determines the set of control parameter data as an action and based on the network state data as a state, thereby improving a probability of achieving a target condition at the base station as reward that results from the action; and transmitting the set of control parameter data to the radio access network intelligent controller, causing the base station to update control parameters according to the set of control parameter data. The base station is associated with a 5G multi-access edge computing and core network, and wherein the deep reinforcement-based learning model includes a trained deep neural network. The radio access network intelligent controller includes a near real-time radio access network intelligent controller, and wherein the deep reinforcement-based learning model includes a near real-time deep reinforcement-based learning model. The network state data includes at least one of: a channel condition, a user-requested data rate, latency, reliability data, location data associated with the base station, traffic load data, or quality-of-service parameter data. The deep reinforcement-based learning model includes a deep convolutional neural network. The set of control parameter data includes at least one of: a level of priority associated with scheduling data transmission associated with user equipment connected to the base station, a cyclic prefix length, a first value associated with reference signal density, a second value associated with a signal transmission power, or a third value associated with a mobility management parameter. The target condition includes at least one of: target spectral efficiency of radio signals at the base station, target latency data, target reliability of the base station, target energy efficiency level at the base station, or target fairness values associated with allocating computing resources to user equipment at the base station. The transmitting the set of control parameter data uses E2 Control interface of Open Radio Access Network (RAN) protocols, and wherein the receiving of the network state data is according to E2 Monitor interface of Open RAN protocols. The predetermined time interval is less than or equal to 10 milliseconds. The method further comprises performing offline training of the deep reinforcement-based learning model using training data, wherein the training data includes a set of truthful network state data as the state, truthful control parameter data as the action, and truthful target conditions as rewards.

In another aspect, a system for updating a set of control parameter data associated with a base station is provided. The system comprises a processor; and a memory storing computer-executable instructions that when executed by the processor cause the system to execute operations comprising: obtaining network state data by transmitting, according to a predetermined time interval, a request to a radio access network intelligent controller for network state data associated with the base station; determine, based on the network state data, the set of control parameter data using a deep reinforcement-based learning model, wherein the deep reinforcement-based learning model determines the set of control parameter data as an action and based on the network state data as a state, thereby improving a probability of achieving a target condition at the base station as reward that results from the action; and transmitting the set of control parameter data to the radio access network intelligent controller, causing the base station to update control parameters according to the set of control parameter data. The base station and the radio access network intelligent controller are associated with a 5G multi-access edge computing and core network, and wherein the deep reinforcement-based learning model includes a trained deep convolutional neural network. The radio access network intelligent controller includes a real-time radio access network intelligent controller, and wherein the deep reinforcement-based learning model includes a real-time deep reinforcement-based learning model. The network state data includes at least one of: a channel condition, a user-requested data rate, latency, reliability data, location data associated with the base station, traffic load data, or quality-of-service parameter data. The set of control parameter data includes at least one of: a level of priority associated with scheduling data transmission associated with user equipment connected to the base station, a cyclic prefix length, a first value associated with reference signal density, a second value associated with a signal transmission power, or a third value associated with a mobility management parameter. The target condition includes at least one of: target spectral efficiency of radio signals at the base station, target latency data, target reliability of the base station, target energy efficiency level at the base station, or target fairness values associated with allocating computing resources to user equipment at the base station.

In yet another aspect, a device for deep reinforcement-based learning of control parameters associated with a base station of a 5G network is provided. The device comprises a memory; and a processor configured to execute operations comprising: transmitting, according to a predetermined time interval, a first request for receiving network state data; receiving the network state data from a radio access network intelligent controller; determine, based on the network state data, a set of control parameter data using a deep reinforcement-based learning model, wherein the deep reinforcement-based learning model determines the set of control parameter data as an action and based on the network state data as a state, thereby improving a probability of achieving a target condition at the base station as reward that results from the action; and transmitting the set of control parameter data. The processor that is further configured to execute operations comprises transmitting the first request for the network state data to the radio access network intelligent controller; causing the radio access network intelligent controller to transmit a second request for the network state data to the base station using E2 Control interface of Open RAN; causing, the radio access network intelligent controller to receive the network state data from the base station using E2 Monitor interface of Open RAN; and causing the base station to update control parameters according to the set of control parameter data. The processor that is further configured to execute operations comprises transmitting the set of control parameter data to the radio access network intelligent controller; causing the radio access network intelligent controller to transmit the set of control parameter data to the base station using E2 Control interface of Open RAN; and causing the base station to update control parameter setting according to the set of control parameter data. The deep reinforcement-based learning model includes a deep convolutional neural network. The network state data includes at least one of: a channel condition, a user-requested data rate, latency, reliability data, location data associated with the base station, traffic load data, or quality-of-service parameter data, wherein the set of control parameter data includes at least one of: a level of priority associated with scheduling data transmission associated with user equipment connected to the base station, a cyclic prefix length, a first value associated with reference signal density, a second value associated with a signal transmission power, or a third value associated with a mobility management parameter, and wherein the target condition includes at least one of: target spectral efficiency of radio signals at the base station, target latency data, target reliability of the base station, target energy efficiency level at the base station, or target fairness values associated with allocating computing resources to the user equipment at the base station.

Any of the one or more above aspects in combination with any other of the one or more aspect. Any of the one or more aspects as described herein.

What is claimed is:

1. A computer-implemented method, comprising:
obtaining network state data by transmitting, according to a predetermined time interval, a request to a radio access network intelligent controller for network state data associated with a base station;
determine, based on the network state data, a set of control parameter data using a deep reinforcement-based learning model, wherein the deep reinforcement-based learning model determines the set of control parameter data as an action and based on the network state data as a state, thereby improving a probability of achieving a target condition at the base station as reward that results from the action; and
transmitting the set of control parameter data to the radio access network intelligent controller, causing the base station to update control parameters according to the set of control parameter data.

2. The computer-implemented method according to claim 1, wherein the base station is associated with a 5G multi-access edge computing and core network, and wherein the deep reinforcement-based learning model includes a trained deep neural network.

3. The computer-implemented method according to claim 1, wherein the radio access network intelligent controller includes a near real-time radio access network intelligent controller, and wherein the deep reinforcement-based learning model includes a near real-time deep reinforcement-based learning model.

4. The computer-implemented method according to claim 1, wherein the network state data includes at least one of:
a channel condition,
a user-requested data rate,
latency,
reliability data,
location data associated with the base station,
traffic load data, or
quality-of-service parameter data.

5. The computer-implemented method according to claim 1, wherein the deep reinforcement-based learning model includes a deep convolutional neural network.

6. The computer-implemented method according to claim 1, wherein the set of control parameter data includes at least one of:
a level of priority associated with scheduling data transmission associated with user equipment connected to the base station,
a cyclic prefix length,
a first value associated with reference signal density,
a second value associated with a signal transmission power, or
a third value associated with a mobility management parameter.

7. The computer-implemented method according to claim 1, wherein the target condition includes at least one of:
target spectral efficiency of radio signals at the base station,
target latency data,
target reliability of the base station,
target energy efficiency level at the base station, or
target fairness values associated with allocating computing resources to user equipment at the base station.

8. The computer-implemented method according to claim 1, wherein the transmitting the set of control parameter data uses E2 Control interface of Open Radio Access Network (RAN) protocols, and
wherein the receiving of the network state data is according to E2 Monitor interface of Open RAN protocols.

9. The computer-implemented method according to claim 1, wherein the predetermined time interval is less than or equal to 10 milliseconds.

10. The computer-implemented method according to claim 1, further comprising:
performing offline training of the deep reinforcement-based learning model using training data, wherein the training data includes a set of truthful network state data as the state, truthful control parameter data as the action, and truthful target conditions as rewards.

11. A system for updating a set of control parameter data associated with a base station, the system comprising:
a processor; and
a memory storing computer-executable instructions that when executed by the processor cause the system to execute operations comprising:
obtaining network state data by transmitting, according to a predetermined time interval, a request to a radio access network intelligent controller for network state data associated with the base station;
determine, based on the network state data, the set of control parameter data using a deep reinforcement-based learning model, wherein the deep reinforcement-based learning model determines the set of control parameter data as an action and based on the network state data as a state, thereby improving a probability of achieving a target condition at the base station as reward that results from the action; and
transmitting the set of control parameter data to the radio access network intelligent controller, causing the base station to update control parameters according to the set of control parameter data.

12. The system according to claim 11, wherein the base station and the radio access network intelligent controller are associated with a 5G multi-access edge computing and core network, and wherein the deep reinforcement-based learning model includes a trained deep convolutional neural network.

13. The system according to claim 11, wherein the radio access network intelligent controller includes a real-time radio access network intelligent controller, and wherein the deep reinforcement-based learning model includes a real-time deep reinforcement-based learning model.

14. The system according to claim 11, wherein the network state data includes at least one of:
a channel condition,
a user-requested data rate,
latency,
reliability data,
location data associated with the base station,
traffic load data, or
quality-of-service parameter data.

15. The system according to claim 11, wherein the set of control parameter data includes at least one of:
a level of priority associated with scheduling data transmission associated with user equipment connected to the base station,
a cyclic prefix length,
a first value associated with reference signal density,
a second value associated with a signal transmission power, or
a third value associated with a mobility management parameter.

16. The system according to claim 11, wherein the target condition includes at least one of:
target spectral efficiency of radio signals at the base station,
target latency data,
target reliability of the base station,
target energy efficiency level at the base station, or
target fairness values associated with allocating computing resources to user equipment at the base station.

17. A device for deep reinforcement-based learning of control parameters associated with a base station of a 5G network, comprising:
a memory; and
a processor configured to execute operations comprising:
transmitting, according to a predetermined time interval, a first request for receiving network state data;
receiving the network state data from a radio access network intelligent controller;
determine, based on the network state data, a set of control parameter data using a deep reinforcement-based learning model, wherein the deep reinforcement-based learning model determines the set of control parameter data as an action and based on the network state data as a state, thereby improving a probability of achieving a target condition at the base station as reward that results from the action; and
transmitting the set of control parameter data.

18. The device according to claim 17, the processor further configured to execute operations comprising:
transmitting the first request for the network state data to the radio access network intelligent controller;
causing the radio access network intelligent controller to transmit a second request for the network state data to the base station using E2 Control interface of Open RAN;
causing, the radio access network intelligent controller to receive the network state data from the base station using E2 Monitor interface of Open RAN; and
causing the base station to update control parameters according to the set of control parameter data.

19. The device according to claim 17, the processor further configured to execute operations comprising:
transmitting the set of control parameter data to the radio access network intelligent controller;
causing the radio access network intelligent controller to transmit the set of control parameter data to the base station using E2 Control interface of Open RAN; and
causing the base station to update control parameter setting according to the set of control parameter data.

20. The device according to claim 17,
wherein the deep reinforcement-based learning model includes a deep convolutional neural network,
wherein the network state data includes at least one of:
a channel condition,
a user-requested data rate,
latency,
reliability data,
location data associated with the base station,
traffic load data, or
quality-of-service parameter data,
wherein the set of control parameter data includes at least one of:
a level of priority associated with scheduling data transmission associated with user equipment connected to the base station,
a cyclic prefix length,
a first value associated with reference signal density,
a second value associated with a signal transmission power, or
a third value associated with a mobility management parameter, and
wherein the target condition includes at least one of:
target spectral efficiency of radio signals at the base station,
target latency data,
target reliability of the base station,
target energy efficiency level at the base station, or
target fairness values associated with allocating computing resources to the user equipment at the base station.
